(19) United States
(12) Patent Application Publication
(10) Pub. No.: US 2023/0255149 A1
(43) Pub. Date: Aug. 17, 2023

(54) ELECTRIC SEEDLING GREENHOUSE

(71) Applicants: Guiyang PENG, Haikou City, Hainan (CN); HAINAN DENDROBIUM HEALTH INDUSTRY CO.,LTD., Haikou City, Hainan (CN)

(72) Inventors: Guiyang PENG, Haikou City, Hainan (CN); Wu LI, Haikou City, Hainan (CN); Xiangming NING, Haikou City, Hainan (CN); Wanxing ZHANG, Haikou City, Hainan (CN); Xiaoping CHEN, Haikou City, Hainan (CN); Haisong FU, Haikou City, Hainan (CN); Guobing WU, Haikou City, Hainan (CN); Wei DENG, Haikou City, Hainan (CN)

(21) Appl. No.: 17/624,289

(22) PCT Filed: Dec. 27, 2021
(86) PCT No.: PCT/CN2021/141695

§ 371 Date: Dec. 31, 2021

(30) Foreign Application Priority Data
Jan. 5, 2021 (CN) 202110008006.3

(51) Int. Cl. A01G 9/22; A01G 9/24; A01G 9/14

(52) U.S. Cl. CPC A01G 9/22; A01G 9/24; A01G 9/14

(57) ABSTRACT

The invention relates to an electric seedling greenhouse, The illumination intensity in the seedling greenhouse is detected by the illumination transmitter, the light intensity information in the seedling greenhouse is transmitted to the information processing module, the light intensity preset value required by plants is set in the information processing module, the shading rate of the first sunshade device is not equal to the shading rate of the second sunshade device, when the light intensity is higher than the preset value, the light intensity collected by the illuminance transmitter is transmitted to the information processing module, and it is judged to meet the value of starting sunshade device, then analyze the light intensity to automatically select the corresponding shading rate of the sunshade device to open and complete the shading. It solves the technical problem that the existing seedling greenhouse needs to manually control the sunshade device, and the shading rate of the sunshade device cannot be changed after it is set, if it needs to be changed, the shading cloth can only be replaced, and it cannot be flexibly shaded, and its practicability is not high.

### TECHNICAL FIELD

The invention relates to the technical field of the seedling greenhouse, in particular to an electric seedling greenhouse.

### BACKGROUND ART

The greenhouse was originally a special equipment for vegetable production, and with the development of production, the application of the greenhouse has become more and more extensive. At present, the greenhouse has been used for the cultivation of potted flowers and cut flowers; the production of fruit trees is used for the cultivation of grapes, strawberries, watermelons, melons, peaches and citrus, etc.; the forestry production is used for the cultivation of tree seedlings, ornamental trees, etc.; the breeding industry is used for raising silkworms, chickens, cattle, pigs, fish and fry, etc.

Some plant seedlings have specific requirements for the amount of light. The existing seedling greenhouses require people to monitor the light intensity of the plant seedlings in the greenhouse in real time, and then artificially control the switch of the sunshade device to turn on and off If the shading rate is too high or too low, it will affect the growth of plant seedlings, however, the shading rate of the existing sunshade device of the seedling greenhouse cannot be changed after setting, if it needs to be changed, the shading cloth can only be replaced, and it cannot be flexibly shaded, and its practicability is not high.

### SUMMARY OF THE INVENTION

This application provides an electric seedling greenhouse, which is used to solve the technical problems that the existing seedling greenhouse needs to manually control the sunshade device, and the shading rate of the sunshade device cannot be changed after being set, if it needs to be changed, the shading cloth can only be replaced, and it cannot be flexibly shaded, and its practicability is not high.

In view of this, this application provides an electric seedling greenhouse, which comprises an illuminance transmitter, information processing module, driving device, first sunshade device and second sunshade device;
the first sunshade device and the second sunshade device are arranged on the top of the seedling greenhouse layer by layer;
the illuminance transmitter is used to collect light intensity data of the seedling greenhouse and send it to the information processing module;
the information processing module is configured to receive the light intensity data, and control the driving device according to the light intensity data so that the driving device drives the first sunshade device and the second sunshade device, wherein the shading rate of the first sunshade device is not equal to the shading rate of the second sunshade device.

Optionally, it also comprises a humidity sensor, a dehumidifying fan and a humidifying device. The humidity sensor is used to detect the humidity data in the shed of the seedling greenhouse, and transmit the humidity data to the information processing module;

the dehumidification fan is connected to the information processing module, and is configured to work when the humidity data is higher than the upper limit of humidity to dehumidify the air in the shed of the seedling greenhouse;
the humidification device is connected to the information processing module, and is configured to work when the humidity data is lower than the lower humidity limit to humidify the air in the shed of the seedling greenhouse.

Optionally, it also comprises a raindrop sensor and a thin film device;
the raindrop sensor and the thin film device are arranged on the top of the seedling greenhouse;
the raindrop sensor is used to sense rainwater information and transmit the rainwater information to the information processing module, so that the information processing module controls the retracting and unfolding of the thin film device.

Optionally , the thin film device includes a driving motor, a transmission mechanism and a thin film;
the driving motor is connected with the transmission mechanism, and the transmission mechanism is connected with the thin film.

Optionally the thin film is a plastic film

Optionally the first sunshade device is a first sunshade net, and the second sunshade device is a second sunshade net.

Optionally the shading rate of the first sunshade device is 75%, and the shading rate of the second sunshade device is 90%.

Optionally the number of the driving devices is at least two.

Optionally the humidification device is a plurality of atomizing nozzles connected with connecting water pipe.

Optionally the raindrop sensor is a wireless raindrop sensor.

It can be seen from the above technical solutions that the embodiments of the present application have the following advantages:

This application provides an electric seedling greenhouse, which comprises an illuminance transmitter, information processing module, driving device, first sunshade device and second sunshade device; the first sunshade device and the second sunshade device are arranged on the top of the seedling greenhouse layer by layer; the illuminance transmitter is used to collect light intensity data of the seedling greenhouse and send it to the information processing module; the information processing module is configured to receive the light intensity data, and control the driving device according to the light intensity data so that the driving device drives the first sunshade device and the second sunshade device, wherein the shading rate of the first sunshade device is not equal to the shading rate of the second sunshade device.

This application provides an electric seedling greenhouse, the illuminance transmitter is used to detect the light intensity in the seedling greenhouse, and then the light intensity information in the seedling greenhouse is transmitted to the information processing module, the light intensity preset value required by plants is set in the information processing module, the shading rate of the first sunshade device is not equal to the shading rate of the second sunshade device, when the light intensity is higher than the preset value, the light intensity collected by the illuminance transmitter is transmitted to the information processing module, and it is judged to meet the value of starting sunshade device, then the light intensity is analyzed to automatically select the sunshade device with the corresponding shading rate, and the driving device drives the sunshade device to open to complete the sunshade, so as to reduce the sun exposure and burn the seedlings. When the light intensity is lower than the preset value, the information processing module controls the driving device to work, and the driving device drives the sunshade device to open to increase the light, so that the photosynthesis of the seedlings can increase the synthesis of organic substances. Realizing the function of flexible sun shading without changing the sunshade device, can automatically select the sunshade device with different shading rate. It solves the technical problem that the existing seedling greenhouse needs to manually control the sunshade device, and the shading rate of the sunshade device cannot be changed after it is set, if it needs to be changed, the shading cloth can only be replaced, and it cannot be flexibly shaded, and its practicability is not high.

### BRIEF DESCRIPTION OF THE DRAWINGS

In order to more clearly describe the technical solutions in the embodiments of the present application, the following will briefly introduce the drawings used in the description of the embodiments, obviously, the drawings in the following description are only some of the implementations recorded in the present application, for those of ordinary skill in the art, other drawings can be obtained based on these drawings.

FIG. 1 is a schematic diagram of the light collection and processing structure of an electric seedling greenhouse provided in an embodiment of the application;

FIG. 2 is a schematic diagram of the system structure of an electric seedling greenhouse provided in an embodiment of the application;

FIG. 3 is a schematic structural diagram of an electric seedling greenhouse provided in an embodiment of the application.

Wherein, the attached drawings are marked as follows: 1. illuminance transmitter; 2. information processing module; 3. driving device; 4. first sunshade device; 5. second sunshade device; 6. humidity sensor; 7. dehumidification fan; 8. humidification device; 9. raindrops Sensor; 10. driving motor; 11. transmission mechanism; 12. thin film; 13. atomizing nozzle.

### DETAILED DESCRIPTION OF SOME EMBODIMENTS

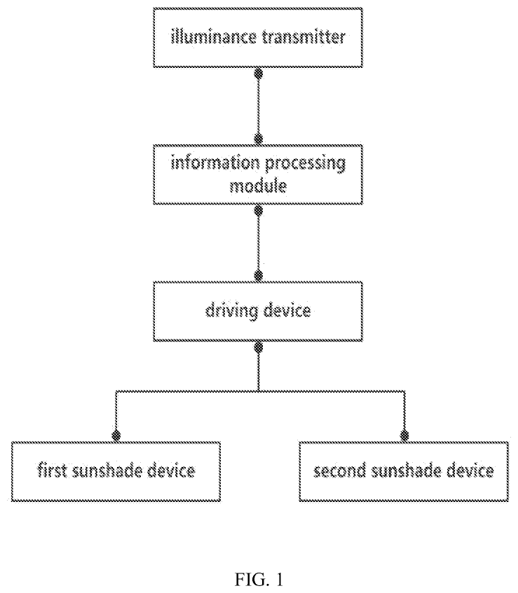

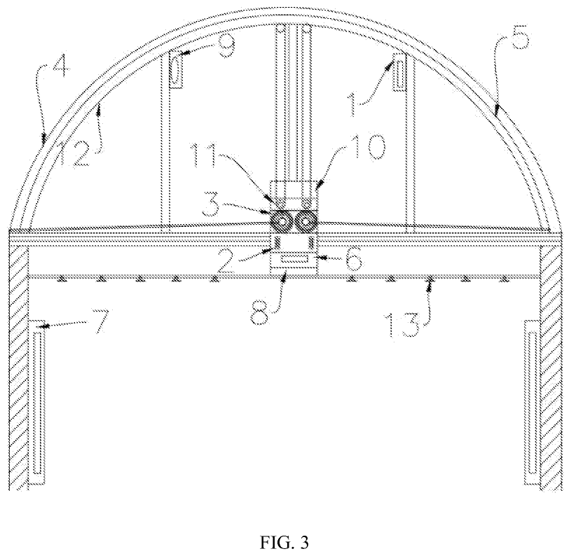

In order to have a better understanding of the technical solutions and beneficial effects of the present invention, the technical solutions of the present invention and the beneficial effects produced will be described in detail below with reference to the accompanying drawings. For ease of understanding, as shown in FIG. 1 and FIG. 3, this application provides an embodiment of an electric seedling greenhouse, which comprises an illumination transmitter 1, information processing module 2, driving device 3, first sunshade device 4 and second sunshade device 5; the first sunshade device 4 and the second sunshade 5 device are arranged on the top of the seedling greenhouse layer by layer; the illuminance transmitter 1 is used to collect light intensity data of the seedling greenhouse and send it to the information processing module 2; the information processing module 2 is configured to receive the light intensity data, and control the driving device 3 according to the light intensity data so that the driving device 3 drives the first sunshade device 4 and the second sunshade device 5, wherein the shading rate of the first sunshade device 4 is not equal to the shading rate of the second sunshade device 5.

It should be noted that, as shown in FIG. 1, the information processing module 2 uses PLC series single-chip microcomputers, which have strong anti-interference ability, low failure rate, easy equipment expansion and easy maintenance, and it's powerful data processing technology and calculation functions can be fully used in intelligent electronic equipment, the illuminance transmitter 1 collects the light intensity of direct sunlight shining through the greenhouse to the inside of the greenhouse, and transmits the collected light intensity to the information processing module 2; the information processing module 2 sets the light intensity required by the plants in advance, the light intensity required by different plant seedlings is different, thus the light intensity range value should be set according to the plant seedlings, when the light intensity value transmitted by the illuminance transmitter 1 is lower than the set range value, the information processing module 2 controls the driving device 3 to work, the selection of the sunshade device should be based on the local season, the shading rate of the first sunshade device 4 Less than the shading rate of the second sunshade device 5, if it is winter, the driving device 3 drives the first sunshade device 4 to retract, and if it is summer, the driving device 3 drives the second sunshade device 5 to retract to increase the light intensity received by the plant seedlings, and increase the photosynthesis of the plant seedlings to synthesize organic substances, when the light intensity value transmitted by the illuminance transmitter 1 is higher than the set range value, if it is winter, the light intensity in winter is weak, the shading rate of the first sunshade device 4 is lower than the shading rate of the second sunshade device 5, so the information processing module 2 chooses to use the first sunshade device 4 for work, and controls the driving device 3 to drive the first sunshade device 4 to open, due to the weak light intensity, choosing a sunshade device with a lower shading rate can not only protect the plant seedlings from being directly exposed to direct sunlight and cause burns, but also provide sufficient light to the plant seedlings, if it is summer, and the summer light intensity is strong, the information processing module 2 chooses to use the first sunshade device 4 for work, and controls the driving device 3 to drive the second sunshade device 5 to open, the sunshade device with high shading rate can give comprehensive protection to the plant seedlings better, choosing the corresponding sunshade device to open and complete the shading, so as to reduce the sun exposure and burn the plant seedlings.

This application provides an electric seedling greenhouse, the illuminance transmitter 1 is used to detect the light intensity in the seedling greenhouse, and then the light intensity information in the seedling greenhouse is transmitted to the information processing module 2, the light intensity preset value required by plants is set in the information processing module 2, the shading rate of the first sunshade device 4 is not equal to the shading rate of the second sunshade device 5, when the light intensity is higher than the preset value, the light intensity collected by the illuminance transmitter 1 is transmitted to the information processing module 2, and it is judged to meet the value of starting sunshade device, then the light intensity is analyzed to automatically select the sunshade device with the corresponding shading rate, and the driving device 3 drives the sunshade device to open to complete the sunshade, so as to reduce the sun exposure and burn the seedlings. When the light intensity is lower than the preset value, the information processing module 2 controls the driving device to work, and the driving device 3 drives the sunshade device to open to increase the light, so that the photosynthesis of the seedlings can increase the synthesis of organic substances. Realizing the function of flexible sunshading without changing the sunshade device, can automatically select the sunshade device with different shading rate. It solves the technical problem that the existing seedling greenhouse needs to manually control the sunshade device, and the shading rate of the sunshade device cannot be changed after it is set, if it needs to be changed, the shading cloth can only be replaced, and it cannot be flexibly shaded, and its practicability is not high.

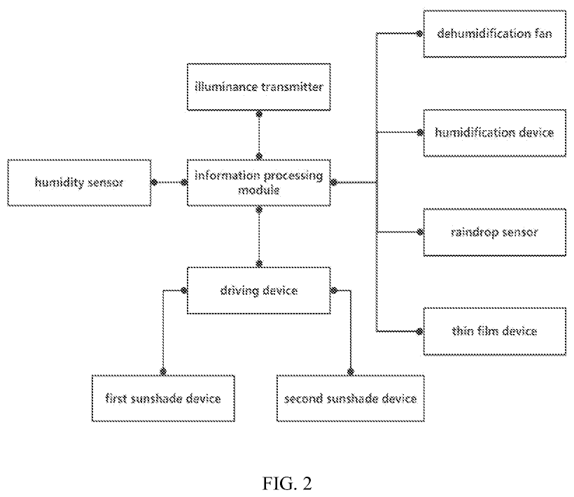

As a further improvement to the above embodiment, for ease of understanding, as shown in FIG. 2, this application provides an embodiment of an electric seedling greenhouse, it also comprises: humidity sensor 6, dehumidification fan 7 and humidification device 8; the humidity sensor 6 is used to detect the humidity data in the shed of the seedling greenhouse, and transmit the humidity data to the information processing module 2; the dehumidification fan 7 is connected to the information processing module 2, and is configured to work when the humidity data is higher than the upper limit of humidity to dehumidify the air in the shed of the seedling greenhouse; the humidification device 8 is connected to the information processing module 2, and is configured to work when the humidity data is lower than the lower humidity limit to humidify the air in the shed of the seedling greenhouse; it also comprises: raindrop sensor 9 and thin film device; the raindrop sensor 9 and the thin film device are arranged on the top of the seedling greenhouse; the raindrop sensor 9 is used to sense rainwater information and transmit the rainwater information to the information processing module 2, so that the information processing module 2 controls the retracting and unfolding of the thin film device; the thin film device includes: a driving motor 10, a transmission mechanism 11 and a thin film 12; the driving motor 10 is connected with the transmission mechanism 11, and the transmission mechanism 11 is connected with the thin film 12.

It should be noted that the humidity sensor 6 is used to collect the humidity inside the seedling greenhouse, and transmit the collected humidity to the information processing module 2, the information processing module 2 pre-sets the range value of the humidity environment that the plants are adapted to, as shown in the FIG. 2, when the information processing module 2 detects that the humidity inside the greenhouse is higher than the set range value, the information processing module 2 transmits the work instruction to the thin film device, and the driving motor 10 in the thin film device starts to work, and the driving motor 10 Provide power for the transmission mechanism 11, which is connected with the thin film 12, besides there are two transmission mechanisms 11, which respectively drive the opening and closing of the thin films 12 on the left and right sides of the roof of the greenhouse, the transmission mechanism 11 is composed of a rotating shaft, a tether, a sliding wheel and a rotating rod, the driving motor 10 is arranged on the support frame of the greenhouse, the rotating shaft is connected with the output shaft of the driving motor 10, one end of the rotating rod is connected with the rotating shaft, the other end of the rotating rod is connected with the sliding wheel, and one end of the thin film 12 is fixed on one side of the top of the greenhouse, the other end of the thin film 12 is connected to the sliding wheel, the tether passes through the sliding wheel and is connected to the rotating shaft, the rotating rod rotates at 90° by driving the motor to close the thin film 12, and then the information processing module 2 transmits the work instruction to the dehumidification fan 7. The dehumidification fan 7 is installed on the side of the greenhouse, the dehumidification fan 7 works to extract the air in the greenhouse, which promotes the enhancement of ventilation in the greenhouse, and plays a role in dehumidification, as shown in FIG. 2, when the information processing module 2 detects the greenhouse When the internal humidity is lower than the set range value, the information processing module 2 sends the work instruction to the humidifying device 8, then the humidifying device 8 implements precise spray irrigation of plant seedlings, avoiding large-area irrigation, so as to achieve the function of saving of water resources and enhancing the internal humidity of the greenhouse. As shown in FIG. 2, if it is raining, the raindrop sensor 9 detects the rainwater information and transmits the rainwater information to the information processing module 2, and the information processing module 2 transmits the work instruction to the thin film device, then the driving motor 10 in the thin film device starts work, the driving motor 10 provides power to the transmission mechanism 11, the transmission mechanism 11 is connected with the thin film 12, and there are two transmission mechanisms 11, which respectively drive the opening and closing of the thin film 12 on the left and right sides of the roof of the greenhouse, the transmission mechanism 11 is composed of a shaft, a tether, and It consists of a sliding wheel and a rotating rod, the driving motor 10 is arranged on the support frame of the greenhouse, the rotating shaft is connected to the output shaft of the driving motor 10, one end of the rotating rod is connected to the rotating shaft, the other end of the rotating rod is connected to the sliding wheel, and one end of the thin film 12 is fixed on one side of the top of the greenhouse, the other end of the film 12 is connected to the sliding wheel, and the tether passes through the sliding wheel and is connected to the rotating shaft. Through the information processing module 2 provided, the transmission mechanism 11 is controlled to drive the opening and closing of the thin film 12 according to the light conditions, the rotating rod rotates 90° through the driving motor 10 to realize the opening and closing of the thin film 12, while the rotating rod rotates at 90°, the sliding wheel also rotates through the tether connected to the rotating shaft, and the sliding wheel rotates 360° to recover the thin film 12. The thin film 12 is connected to the rotating shaft and the sliding wheel by a tether, which can ensure the flatness of the thin film 12 and prevent wrinkle problems during the opening and closing of the thin film 12.

As a further improvement to the above embodiment, for ease of understanding, as shown in FIG. 3, this application also provides an embodiment of an electric seedling greenhouse, the thin film 12 is a plastic film; the first sunshade device 4 is a first sunshade net, and the second sunshade device 5 is a second sunshade net; the shading rate of the first sunshade device 4 is 75%, and the shading rate of the second sunshade device 5 is 90%; the number of the driving devices 3 is at least two; the humidification device 8 is a plurality of atomizing nozzles 13 connected with connecting water pipe; the raindrop sensor 9 is a wireless raindrop sensor.

It should be noted that the material of the thin film 12 is made of plastic, which has strong light transmittance and heat preservation effect, which is of great help to the growth of plants. The first sunshade net is a sunshade net with 75% shading rate, and the second sunshade net is a sunshade net with 90% shading rate, which can not only prevent the seedlings from being burned by excessive light intensity, but also ensure that the seedlings can absorb enough sunlight. There are at least two driving devices 3, which are used for the first and second sunshade nets, respectively, humidity sensor 6 can also choose a network-type temperature and humidity sensor, a network-type temperature and humidity sensor, which can collect temperature and humidity data and upload it to the server via Ethernet/WiFi/GPRS. It can make full use of the established communication network to realize long-distance data collection and transmission, and realize centralized monitoring of temperature and humidity data, and it can greatly reduce the amount of construction, improve construction efficiency and maintenance costs. The raindrop sensor 9 uses a wireless raindrop sensor, which is easy to install and can be installed in a suitable position in the greenhouse.

Although the present invention has been described using the above-mentioned preferred embodiments, it is not intended to limit the scope of protection of the present invention, anyone skilled in the art can make various changes and modifications to the above-mentioned embodiments without departing from the spirit and scope of the present invention, and that still belong to the scope of protection of the present invention, so the protection scope of the present invention is defined by the claims.

1. An electric seedling greenhouse, charactered in that it comprises:
illuminance transmitter, information processing module, driving device, first sunshade device and second sunshade device;
the first sunshade device and the second sunshade device are arranged on the top of the seedling greenhouse layer by layer;
the illuminance transmitter is used to collect light intensity data of the seedling greenhouse and send it to the information processing module;
the information processing module is configured to receive the light intensity data, and control the driving device according to the light intensity data so that the driving device drives the first sunshade device and the second sunshade device, wherein the shading rate of the first sunshade device is not equal to the shading rate of the second sunshade device.

2. The electric seedling greenhouse of claim 1, charactered in that it also comprises: humidity sensor, dehumidification fan and humidification device;
the humidity sensor is used to detect the humidity data in the shed of the seedling greenhouse, and transmit the humidity data to the information processing module;
the dehumidification fan is connected to the information processing module, and is configured to work when the humidity data is higher than the upper limit of humidity to dehumidify the air in the shed of the seedling greenhouse;
the humidification device is connected to the information processing module, and is configured to work when the humidity data is lower than the lower humidity limit to humidify the air in the shed of the seedling greenhouse.

3. The electric seedling greenhouse of claim 2, charactered in that it also comprises: raindrop sensor and thin film device;
the raindrop sensor and the thin film device are arranged at the top of the seedling greenhouse;
the raindrop sensor is used to sense rainwater information and transmit the rainwater information to the information processing module, so that the information processing module can control the retraction of the thin film device can control the retraction of the thin film device.

4. The electric seedling greenhouse of claim 3, charactered in that the thin film device includes: a driving motor, a transmission mechanism and a thin film;
the driving motor is connected with the transmission mechanism, and the transmission mechanism is connected with the thin film.

5. The electric seedling greenhouse of claim 4, charactered in that the thin film is a plastic film

6. The electric seedling greenhouse of claim 1, charactered in that the first sunshade device is a first sunshade net, and the second sunshade device is a second sunshade net.

7. The electric seedling greenhouse of claim 1 or 6, charactered in that the shading rate of the first sunshade device is 75%, and the shading rate of the second sunshade device is 90%.

8. The electric seedling greenhouse of claim 1, charactered in that the number of the driving devices is at least two.

9. The electric seedling greenhouse of claim 2, charactered in that the humidification device is a plurality of atomizing nozzles connected with connecting water pipe.

10. The electric seedling greenhouse of claim 3, charactered in that the raindrop sensor is a wireless raindrop sensor.
